(19) United States
(12) Patent Application Publication
(10) Pub. No.: US 2019/0331243 A1
(43) Pub. Date: Oct. 31, 2019

(54) DESTRUCTIBLE SEALING DISK AND METHODS ASSOCIATED THEREWITH

(71) Applicant: CoorsTek, Inc., Golden, CO (US)

(72) Inventor: Patrick Stone, Cypress, TX (US)

(73) Assignee: CoorsTek, Inc., Golden, CO (US)

(21) Appl. No.: 16/391,994

(22) Filed: Apr. 23, 2019

Related U.S. Application Data
(60) Provisional application No. 62/663,892, filed on Apr. 27, 2018.

(51) Int. Cl. F16K 17/40; E21B 41/00

(52) U.S. Cl. CPC F16K 13/04; E21B 41/00

(57) ABSTRACT

A drill piping or tubing pressure seal includes a diameter-spanning body portion. The diameter-spanning body portion includes a high-pressure side, a low-pressure side and a plug receptacle passing through the diameter-spanning body portion from the high-pressure side to the low-pressure side. The high-pressure side and the low-pressure side of the diameter-spanning body portion include a protective coating; however, an interior surface of the plug receptacle located between the high-pressure side and the low-pressure side does not include the protective coating. In addition, a plug is configured to be located within the plug receptacle, and the plug is configured to be retained within the plug receptacle by an anchor element to maintain the plug within the plug receptacle until a breakaway force of the anchor element is exceeded. A gasket is located between a portion of the plug and the plug receptacle.

### CROSS-REFERENCE TO RELATED APPLICATION

The present application claims priority to and the benefit of U.S. Provisional Patent Application No. 62/663,892, filed on Apr. 27, 2018, which is incorporated herein by reference in its entirety.

### TECHNICAL FIELD

The present disclosure generally relates to devices used to form a seal in a longitudinally extensive structure. More specifically, the present disclosure relates to destructible seals or sealing disks used in piping or tubing, such as piping or tubing used in an oil and gas well.

### BACKGROUND

Devices are used to create a temporary seal within piping, such as drill piping and/or tubing. Such devices allow fluids on one side of the seal to be blocked from another side of the seal. However, problems continue to exist concerning removal of sealing disks from the piping and/or tubing. Accordingly, there is a continuing need for improvements to such sealing disks.

### SUMMARY

It is to be understood that the one or more present inventions include a variety of different versions or embodiments, and this Summary is not meant to be limiting or all-inclusive. This Summary provides some general descriptions of some of the embodiments, but may also include some more specific descriptions of other embodiments.

In at least one embodiment, a drill piping or tubing pressure seal is provided, comprising: diameter-spanning body portion connected to a circumferential rim portion, the diameter-spanning body portion including a high-pressure side, a low-pressure side and a plug receptacle passing through the diameter-spanning body portion from the high-pressure side to the low-pressure side, wherein the high-pressure side and the low-pressure side of the diameter-spanning body portion include a protective coating, and wherein an interior surface of the plug receptacle located between the high-pressure side and the low-pressure side does not include the protective coating; a plug configured to be located within the plug receptacle, the plug configured to be retained within the plug receptacle by an anchor element to maintain the plug within the plug receptacle until a breakaway force of the anchor element is exceeded; and a gasket located between a portion of the plug and the plug receptacle.

In at least one embodiment, the diameter-spanning body portion and the circumferential rim portion are a single monolithic piece.

In at least one embodiment, the diameter-spanning body portion and the circumferential rim portion are integrally formed.

In at least one embodiment, the diameter-spanning body portion and the circumferential rim portion are made of a corrodible material configured to structurally degrade when the plug receptacle is exposed to common oil and gas well fluids, or acids commonly used in oil and gas wells.

In at least one embodiment, the protective coating comprises phenolic epoxy.

In at least one embodiment, the anchor element includes frangible threads on the plug configured for threadably mating with mating threads on the plug receptacle.

In at least on embodiment, the plug is made of aluminum, an aluminum alloy or a copper alloy.

In at least one embodiment, the anchor element includes a frangible pin configured to contact a portion of the plug.

In at least one embodiment, the frangible pin is configured to extend through an anchor port of the plug.

In at least one embodiment, the frangible pin is configured to contact the low-pressure side of the diameter-spanning body portion when the breakaway force is applied to the anchor element.

In at least one embodiment, the diameter-spanning body portion is domed-shaped, and wherein the high-pressure side is a convex surface and the low-pressure side is a concave surface.

In at least one embodiment, the high pressure side of the diameter-spanning body portion is a convex surface.

In at least one embodiment, the high pressure side of the diameter-spanning body portion is substantially flat.

In at least one embodiment, the diameter-spanning body portion is not domed-shaped.

In at least one embodiment, the gasket comprises an elastomeric material.

In at least one embodiment, the gasket comprises an adhesive.

In at least one embodiment, the gasket comprises an O-ring.

In at least one embodiment, at least a portion of the plug receptacle comprises a transversely oriented circular-shaped cross section.

In at least one embodiment, at least a portion of the plug receptacle comprises a transversely oriented polygon-shaped cross section.

In at least one embodiment, a drill piping or tubing pressure seal is provided, comprising: a diameter-spanning body portion including a high-pressure side, a low-pressure side and a plug receptacle passing through the diameter-spanning body portion from the high-pressure side to the low-pressure side, wherein the high-pressure side and the low-pressure side of the diameter-spanning body portion include a protective coating, and wherein an interior surface of the plug receptacle located between the high-pressure side and the low-pressure side does not include the protective coating; a plug configured to be located within the plug receptacle, the plug configured to be retained within the plug receptacle by an anchor element to maintain the plug within the plug receptacle until a breakaway force of the anchor element is exceeded; and a gasket located between a portion of the plug and the plug receptacle. In at least one embodiment, the high-pressure side of the diameter-spanning portion is flat or substantially flat. In at least one embodiment, the low-pressure side of the diameter-spanning portion is flat or substantially flat. In at least one embodiment, the gasket comprises an elastomeric material.

In use, a tool holding the sealing disk is placed into a pipe or section of tubing, such as a piping or tubing of an oil and gas well. The tool holding the sealing disk is positioned as desired, such as by moving the tool in a longitudinal direction through the piping or tubing. Additional steps may include manipulation of the pressure on the high-pressure side of a diameter-spanning body portion of the sealing disk to facilitate a downhole process, such as inducing a relatively high pressure environment located on the high-pressure side of the sealing disk. Once the sealing disk is no longer needed, a higher pressure can be applied to the low-pressure side of the diameter-spanning body portion of the sealing disk to cause a plug to eject from the diameter-spanning body portion of the sealing disk, thereby facilitating the corrosion or dissolution of the diameter-spanning body portion of the sealing disk.

In at least one embodiment, a breakaway force can be applied so that a plug is removed from a diameter-spanning body portion of a sealing disk, wherein interior plug receptacle surfaces begin to corrode until all or substantially all of the diameter-spanning body portion of the sealing disk is corroded or dissolved, thereby resulting in the inner diameter of the piping or tubing being fully opened or substantially fully opened.

As used herein, “at least one,” “one or more,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C” and “A, B, and/or C” means A alone, B alone, C alone, A and B together, A and C together, B and C together, or A, B and C together.

The use of the word “substantially” as a qualifier to certain features or effects in this disclosure is intended to simply mean that any deviations are within tolerances that would normally be expected by the skilled person in the relevant field.

Various embodiments of the one or more present inventions are set forth in the attached figures and in the Detailed Description as provided herein and as embodied by the claims. It should be understood, however, that this Summary does not contain all of the aspects and embodiments of the one or more present inventions, is not meant to be limiting or restrictive in any manner, and that the invention(s) as disclosed herein is/are understood by those of ordinary skill in the art to encompass obvious improvements and modifications thereto.

Additional advantages of the one or more present inventions will become readily apparent from the following discussion, particularly when taken together with the accompanying drawings.

### BRIEF DESCRIPTION OF THE DRAWINGS

The accompanying drawings are incorporated into and form a part of the specification to illustrate one or more examples of the present disclosure, to include one or more embodiments as described herein. These drawings, together with the description, explain the principles of the disclosure. The drawings simply illustrate preferred and alternative examples of how the embodiments may be made and used and are not to be construed as limiting the disclosure to only the illustrated and described exemplary embodiments. Further features and advantages will become apparent from the following, more detailed, description of the various aspects and embodiments of the disclosure, as illustrated by the drawings referenced below.

FIG. 1 is a plan view of an exemplary embodiment of a destructible sealing disk according to the present disclosure;

FIG. 2 is a side elevation view of the destructible sealing disk shown in FIG. 1;

FIG. 3 is a cross-sectional view of a destructible sealing disk with an exemplary embodiment of a plug held by an anchor element;

FIG. 4 is a cross-sectional view of the plug shown in FIG. 3;

FIG. 5 is a plan view of an O-ring used with the plug shown in FIG. 4;

FIG. 6 is a cross-sectional view of the device shown in FIG. 3, and further including arrows representing normal operating pressure;

FIG. 7 is a cross-sectional view of the device shown in FIG. 3, and further including arrows representing pressure conditions used to cause the plug to eject leading to disintegration of the destructible sealing disk;

FIG. 8 is a cross-sectional view of a destructible sealing disk with another embodiment of a plug held by an anchor element;

FIG. 9 is a cross-sectional view of the plug shown in FIG. 8;

FIG. 10 is a plan view of an O-ring used with the plug shown in FIG. 9;

FIG. 11 is a cross-sectional view of a destructible sealing disk with yet another embodiment of a plug held by an anchor element;

FIG. 12 is a cross-sectional view of the plug shown in FIG. 11;

FIG. 13 is a plan view of an O-ring used with the plug shown in FIG. 12;

FIG. 14 is a cross-sectional view of a destructible sealing disk with still yet another embodiment of a plug held by an anchor element;

FIG. 15 is a cross-sectional view of the plug shown in FIG. 14;

FIG. 16 is a plan view of an O-ring used with the plug shown in FIG. 15;

FIG. 17 is a cross-sectional view of a destructible sealing disk with still another embodiment of a plug held by an anchor element;

FIG. 18 is a cross-sectional view of the plug shown in FIG. 17, including a portion of a diameter-spanning body portion;

FIG. 19 is a side elevation view of the plug shown in FIGS. 17 and 18;

FIG. 20 is a plan view of an O-ring used with the plug shown in FIGS. 17 and 18;

FIG. 21 is a cross-sectional view of another exemplary embodiment of a destructible sealing disk according to the present disclosure; and

FIG. 22 is a cross-sectional view of still another exemplary embodiment of a destructible sealing disk according to the present disclosure.

Corresponding reference characters indicate corresponding parts throughout the several views. It should be understood that the drawings are not necessarily to scale, including that the separation between the edges of the plugs and the plug receptacles are exaggerated for illustration purposes. Accordingly, the plugs may fit tighter within the plug receptacles than what may be inferred from the illustrations. In certain instances, details that are not necessary for an understanding of the disclosure or that render other details difficult to perceive may have been omitted. It should be understood, of course, that the disclosure is not necessarily limited to the particular embodiments illustrated herein.

### DETAILED DESCRIPTION

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof, as well as additional items.

This disclosure is directed to destructible sealing disks (also referred to herein as “destructible seals”) used in piping or tubing, such as piping and/or tubing used in oil and gas wells. The destructible sealing disks allow a seal to be formed to prevent or limit fluids from passing across the boundary formed by the destructible sealing disks. However, the destructible sealing disks can be destroyed within the piping and/or tubing by application of appropriate fluids and/or pressures as described further below.

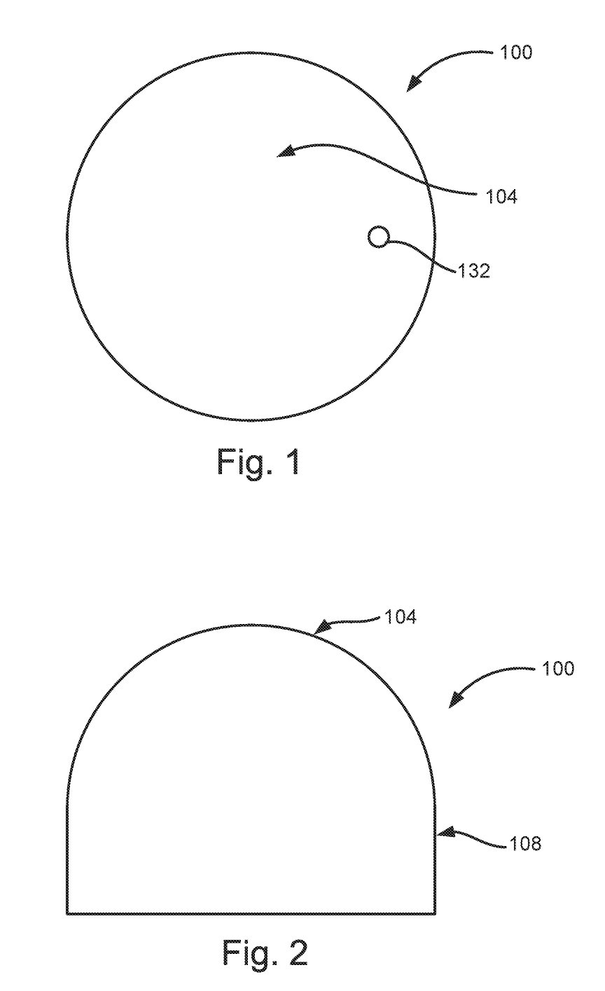

Referring now to FIGS. 1-2, an exemplary embodiment of a destructible sealing disk 100 according to the present disclosure is illustrated. In at least some embodiments, the destructible sealing disk 100 includes a diameter-spanning body portion 104 connected to a circumferential rim portion 108. More particularly, in at least some embodiments the diameter-spanning body portion 104 may be domed shaped. In addition, in at least some embodiments, the dome shape may include a portion of a spherical surface, such as half a sphere. The circumferential rim portion 108 is configured to be retained within a tool (not shown) that holds the destructible sealing disk 100 within the piping or tubing (also not shown).

Referring now to FIG. 3, a cross-sectional view of a destructible sealing disk 100 is shown. The destructible sealing disk 100 includes a high-pressure side 112 and a low-pressure side 116. More particularly, the high-pressure side 112 is to be oriented to face the high pressure environment within the piping or tubing during use of the destructible sealing disk 100. In general, the high-pressure side 112 faces the distal direction of the piping or tubing within which it is positioned, and the low-pressure side 116 faces the proximal direction of the piping or tubing that leads back to, for example, the wellhead of an oil and gas well.

In at least some embodiments, the high-pressure side 112 includes a convex surface and the low-pressure side 116 includes a concave surface. In at least some embodiments, the thickness 120 of the destructible sealing disk 100 between the high-pressure side 112 and the low-pressure side 116 is substantially uniform. For example, the thickness 120 of an exemplary destructible sealing disk 100 may be from about 0.18 to 0.38 inches. For example, the thickness 120 of the destructible sealing disk 100 may be about 0.18 inches. Alternatively, the thickness 120 of the destructible sealing disk 100 may be about 0.25 inches. As those skilled in the art will appreciate, the foregoing thicknesses are only examples, and a thinner or thicker thickness 120 may be suitable for certain destructible sealing disks 100 depending upon the materials used to make the destructible sealing disks 100 and the anticipated operating conditions for a given use. Moreover, in at least some embodiments, the thickness 120 of the destructible sealing disk 100 can vary. By way of example, the thickness 120 of the destructible sealing disk 100 may be between 1 to 75% thicker near the disk center 124 as compared to the thickness near the lateral edge 128 at the circumferential rim 108.

Referring still to FIG. 3, for illustrative purposes, an exemplary embodiment of a plug 132 is depicted along a portion of the diameter-spanning body portion 104. However, it is to be understood that the plug 132 may be positioned anywhere along a portion of the diameter-spanning body portion 104. The plug 132 is configured to be fitted within a plug receptacle 136 of the diameter-spanning body portion 104. Plug 132 includes a plug distal portion 140 and a plug shaft 144, wherein the plug shaft 144 is located proximal to the plug distal portion 140. For plug 132, the plug distal portion 140 includes a wider dimension than the plug shaft 144, with the plug receptacle 136 including a distal receptacle portion 148 that is wider than a receptacle shaft portion 152. Preferably, the plug distal portion 140 is cylindrically shaped and has a first diameter, and the plug shaft 144 is also cylindrically shaped and has a second diameter, wherein the first diameter is greater than the second diameter. In addition, preferably the distal receptacle portion 148 and the receptacle shaft portion 152 are both cylindrically shaped, with the distal receptacle portion 148 having a greater diameter than the receptacle shaft portion 152. A receptacle shoulder 156 prevents the plug 132 from passing into the interior space 160 of the destructible sealing disk 100 because the receptacle shoulder 156 blocks the plug distal portion 140 from advancing into the narrower portion of the receptacle shaft portion 152.

In the exemplary embodiment depicted in FIG. 3, an anchor element 164, such as a frangible pin, serves to prevent the plug 132 from passing distally out the plug receptacle 136 of the diameter-spanning body portion 104 until desired. The anchor element 164 has an engineered failure or separation mode that can be caused to fail and/or separate from the plug 132 under selective circumstances. By way of example, if a plug ejection pressure is applied to the plug 132, the plug ejection pressure will tend to push the plug 132 outward from the diameter-spanning body portion 104. In turn, the outward force on the plug 132 will cause the anchor element 164 to break or separate from the plug 132. More particularly, the anchor element 164 is forced against the normally low-pressure side 116 of the diameter-spanning body portion 104, which breaks or separates the anchor element 164 from the plug 132. By causing the anchor element 164 to break or separate from the plug 132, the plug 132 can be caused to eject or exit the diameter-spanning body portion 104, thereby leading to the destruction of the destructible sealing disk 100, as described in more detail below.

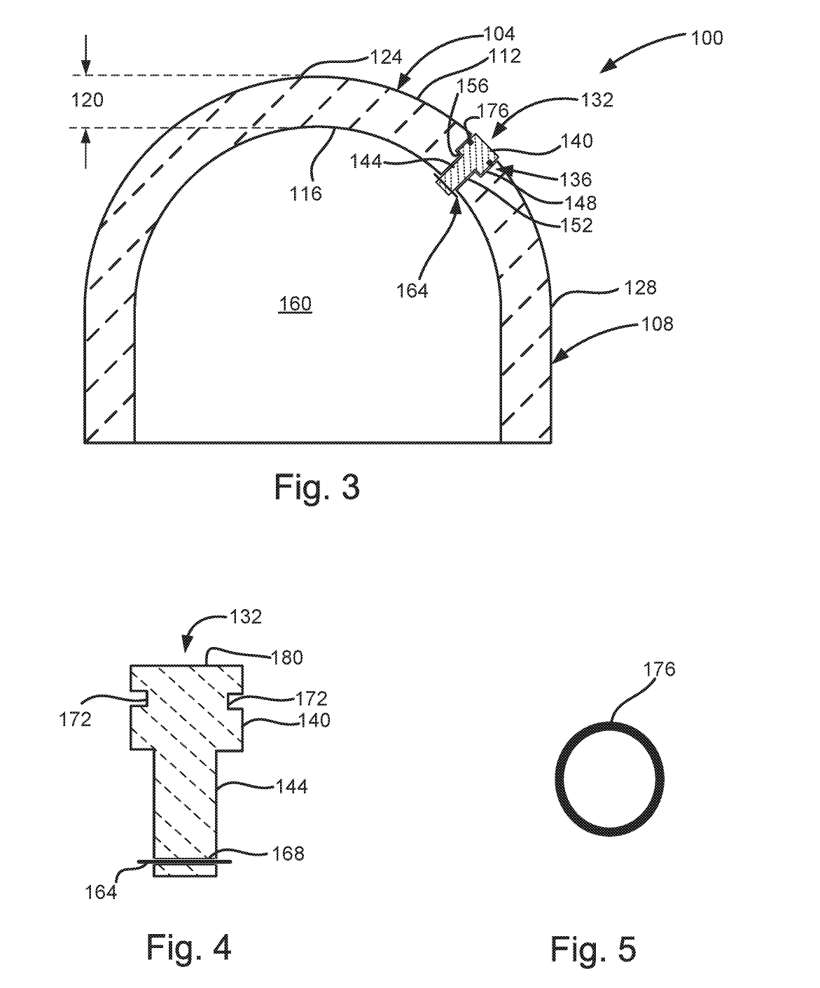

Referring now to FIG. 4, for plug 132, the plug shaft 144 may include an anchor port 168 that receives the anchor element 164, wherein the anchor element 164 may be a breakable or deformable structure, such as a metal pin (e.g., a cotter pin) that can be flared to be retained, but is suited for breaking or otherwise separating from the plug 132 to allow the plug 132 to be ejected from the plug receptacle 136. More particularly, the plug shaft 144 may extend within the interior of the destructible sealing disk 100 and beyond the low-pressure side 116 of the diameter-spanning body portion 104. The anchor element 164 may be a pin as described above that can be passed through the anchor port 168 within the plug shaft 144 to extend on either side of the plug shaft 144. The anchor element 164 possesses material characteristics and qualities that cause the anchor element 164 to break or separate from the plug shaft 144 with the application of a sufficient breakaway force. By way of non-limiting example, the anchor element may be a metal pin, such as a 0.030 inch diameter metal pin, that is transversely oriented relative to a longitudinal axis of the plug 132. Such a transversely oriented pin preferably assists in maintaining the plug 132 within the plug receptacle 136 during shipping, tool installation and deployment of the destructible sealing disk 100 downhole, but can be broken with the application of pressure on the low-pressure side 116 of the diameter-spanning body portion 104, such as a pressure of between 500 psi to 8,000 psi on the low-pressure side 116 greater than the pressure then existing on the high-pressure side 112 of the diameter-spanning body portion 104.

With reference to FIGS. 3-5, the plug distal portion 140 of the plug 132 includes a channel 172 for receiving a gasket, such an O-ring 176, which may be formed of an elastomeric material. The O-ring 176 serves to form a liquid and/or gas barrier to prevent or limit the passage of fluids between the plug 132 and the plug receptacle 136. The channel 172 is preferably located proximal to the plug distal surface 180 of the plug 132.

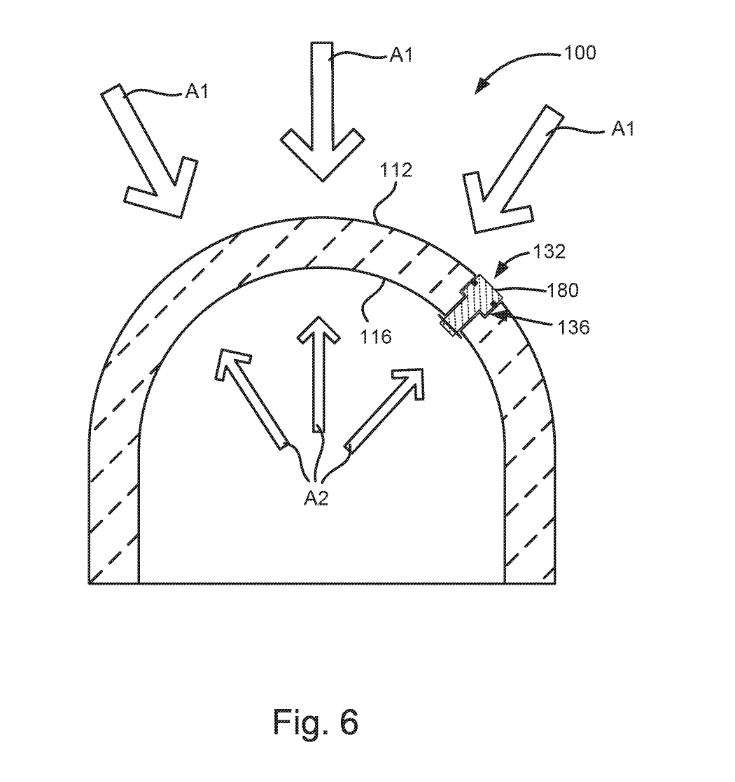

Referring now to FIG. 6, an illustration of potential pressure conditions under normal use of the destructible sealing disk 100 is shown. More particularly, high-pressure arrows A1 illustrate relatively high pressure on the high-pressure side 112 of the diameter-spanning body portion 104. In addition, low-pressure arrows A2 illustrate relatively low pressure on the low-pressure side 116 of the diameter-spanning body portion 104. Accordingly, in normal use, the destructible sealing disk 100 can provide a seal for preventing or limiting mixing of the environments located on either side of the diameter-spanning body portion 104. Under normal operating conditions, the pressure on the high-pressure side 112 of the diameter-spanning body portion may be on the order of 15,000 psi, while the pressure on the low-pressure side 116 may be lower, such as between 0 psi to 15,000 psi.

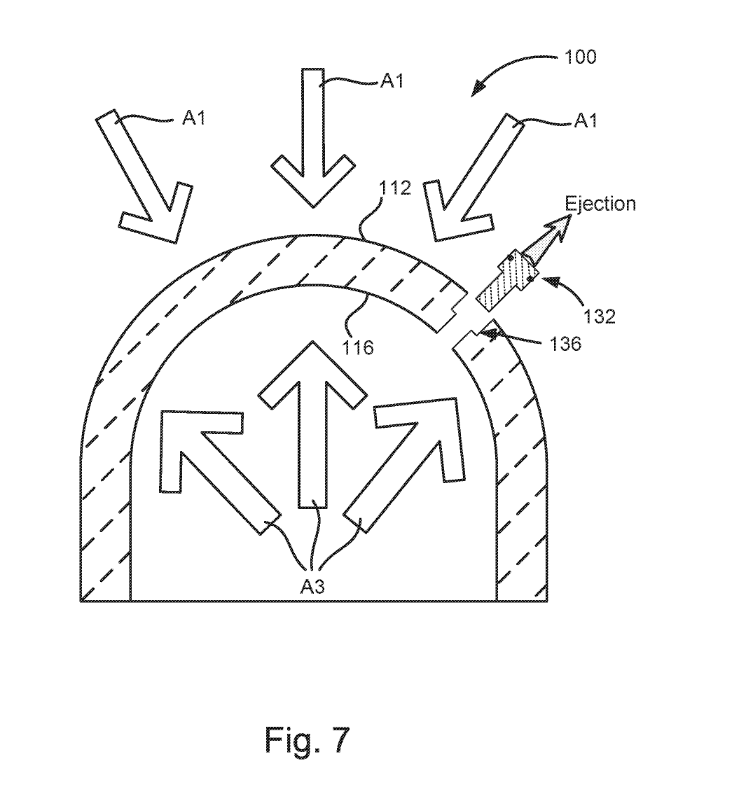

The plug 132 is maintained in plug receptacle 136 because the pressure exerted on the high-pressure side 112, and thus, on the plug distal surface 180, maintains the plug 132 within the plug receptacle 136. Moreover, diameter-spanning body portion 104 resists allowing the plug 132 to be forced inward completely into the interior space 160 of the destructible sealing disk 100 because the receptacle shoulder 156 blocks the plug distal portion 140 from advancing into the narrower portion of the receptacle shaft portion 152. However, and with reference now to FIG. 7, to facilitate destruction of the destructible sealing disk 100, pressure can be increased to a plug ejection pressure within the interior of the destructible sealing disk 100. A breakaway force for shearing the anchor element 164 can be achieved after raising the pressure on the normally low-pressure side 116 of the diameter-spanning body portion 104 above the pressure on the high-pressure side 112 of the diameter-spanning body portion 104, such as by raising the pressure on the low-pressure side 116 to greater than about 500 psi to 8,000 psi above the existing pressure on the high-pressure side 112 of the diameter-spanning body portion 104. More particularly, when pressure is increased on the low-pressure side 116 sufficiently in excess of the pressure on the high-pressure side 112, a breakaway force can be applied to the plug 132. That is, with sufficient pressure applied to the normally low-pressure side 116 of the destructible sealing disk 100, as represented with breakaway-pressure arrows A3, a breakaway force is applied to the plug 132 because the anchor element 164 will be caused to break or separate from the plug 132 as it is forced against the low-pressure side 116. To achieve a breakaway force, the pressure on the low-pressure-side 116 of the diameter-spanning body portion 104 may be greater than the pressure on the high-pressure side 112, such as by approximately 500 psi to 8,000 psi greater than the pressure on the high-pressure side 112 of the diameter-spanning body portion 104. This differential pressure between the low-pressure side 116 and the high-pressure side 112 is selectively provided to cause the anchor element 164 to break or separate from the plug 132.

As a result of causing the anchor element 164 to break or separate from the plug 132, the plug 132 will eject or exit the diameter spanning body portion 104. Thereafter, the pressure of fluid passing through the open plug receptacle 136 will erode and/or sufficiently corrode or dissolve the material of the destructible sealing disk 100, where the term “sufficiently corrode or dissolve” means to adequately cause the corrosion or dissolution of the material of the destructible sealing disk 100 to allow subsequent well operations and/or treatment to continue. This is particularly the case if the destructible sealing disk 100 is formed of a dissolvable material, such as by way of non-limiting example, a coated magnesium based material or another material that readily loses its structural integrity upon exposure to normal oil and gas well fluids and/or an acid used in wells, such as, but not limited to, fluids containing one or more of KCl, NaCl, CaCl and/or CaBr. Accordingly, in at least some embodiments, the destructible sealing disk 100 is preferably made of a magnesium based material that is coated with phenolic epoxy, or alternatively, a metal coating (e.g., a nickel coating) on the high-pressure side 112 and the low-pressure side 116 to protect it from acid exposure. However, preferably no protective coating is applied to the inner surface of the plug receptacle 136; that is, the interior walls of the through hole that form the plug receptacle 136 located between the high-pressure side 112 and the low-pressure side 116 of the diameter-spanning body portion 104. Nonetheless, a coating, such as white lithium grease, may be provided to limit exposure of walls of the plug receptacle 136 to fluids in the piping or tubing while the plug 132 remains in place in the plug receptacle 136, although such grease will readily erode from the plug receptacle 136 once the plug 132 is ejected, thereby allowing corrosion and/or dissolution of the destructible sealing disk 100.

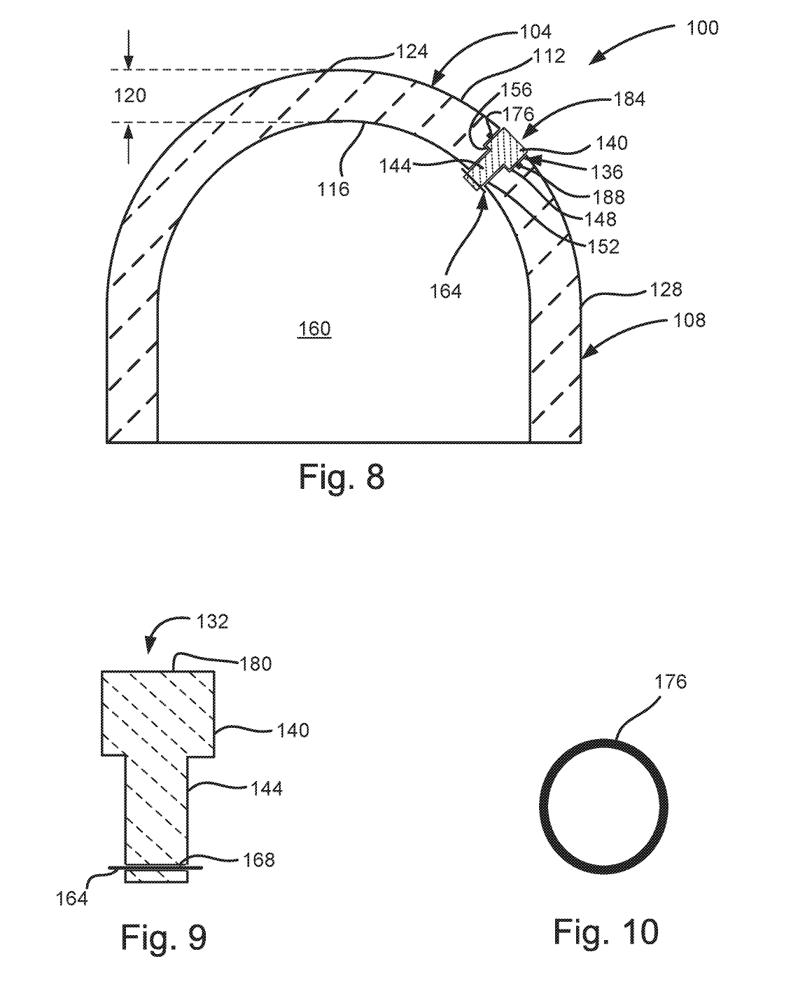

Referring now to FIGS. 8-10, a destructible sealing disk 100 is shown with another embodiment of a plug. More particularly, plug 184 is similar to plug 132, however, plug 184 does not include a channel for an O-ring. As seen in FIG. 8, an O-ring channel 188 is set within the destructible seal disk 100 at a location circumferentially outward of the plug distal portion 140. When making the destructible sealing disk 100 of FIG. 8, the O-ring 176, as seen in FIG. 10, is fitted into the O-ring channel 188, and thereafter the plug 184 is positioned within the plug receptacle 136.

In use, the destructible sealing disk 100 with plug 184 functions similar to that described above for the destructible sealing disk 100 with plug 132. That is, normal operating pressure holds the plug 184 within the diameter-spanning body portion 104 because of the relatively high pressure on the plug distal surface 180. After normal operational use of the destructible sealing disk 100 with plug 184, the plug 184 can be ejected from the plug receptacle 136 of the diameter-spanning body portion 104 by applying a sufficient plug ejection pressure to the normally low-pressure side 116 to cause a breakaway force to break or separate the anchor element 164 from the plug 184. Disintegration of the destructible sealing disk 100 then occurs as described above.

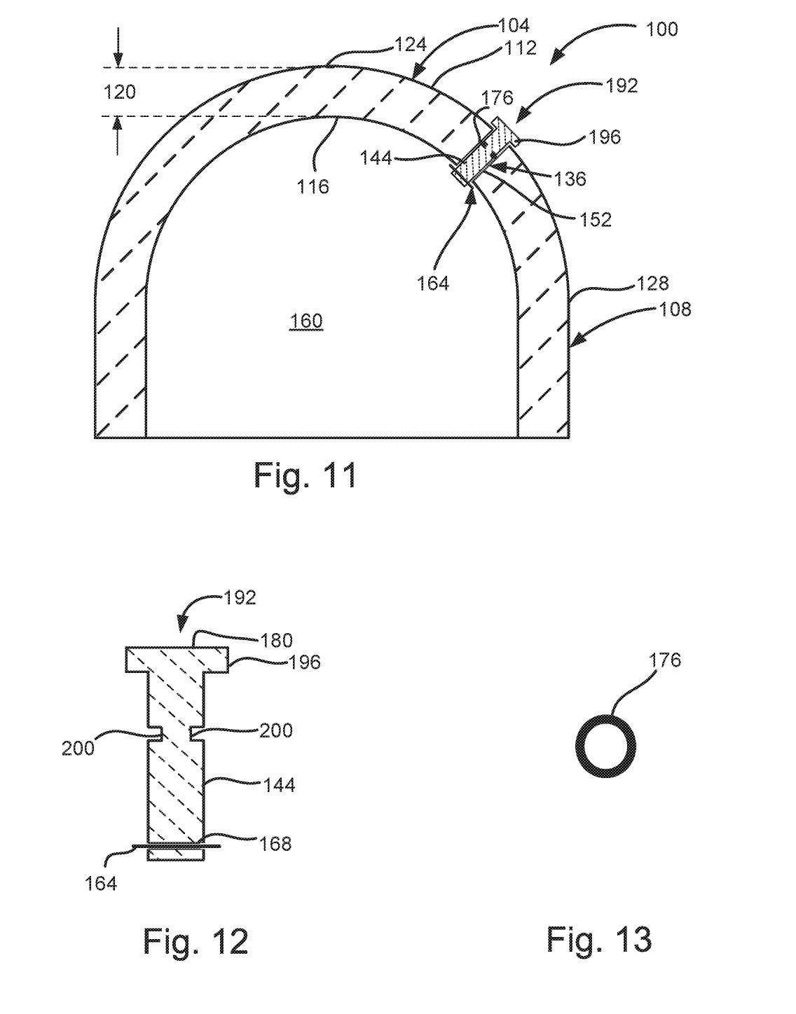

Referring now to FIGS. 11-13, a destructible sealing disk 100 is shown with yet another embodiment of a plug. More particularly, plug 192 includes a plug shaft 144 that is preferably cylindrical in shape and extends substantially the entire thickness of the diameter-spanning body portion 104; that is, from the high-pressure side 112 to the low-pressure side 116. The plug 192 further includes a plug cap 196, wherein the plug cap 196 is larger in effective diameter than the diameter of the plug receptacle 136 that receives the plug shaft 144 of the plug 192. As with plug 132, plug 192 also includes a channel 200 for receiving an O-ring 176; however, the channel 200 is recessed in the plug shaft 144 of plug 192 (whereas the channel 176 of plug 132 is recessed within the plug distal portion 140 of plug 132).

In use, the destructible sealing disk 100 with plug 192 functions similar to that described above for the destructible sealing disk 100 with plug 132 or plug 184. That is, normal operating pressure holds the plug 192 within the diameter-spanning body portion 104 because of the relatively high pressure on the plug distal surface 180. After normal operational use of the destructible sealing disk 100 with plug 192, the plug 192 can be ejected from the plug receptacle 136 of the diameter-spanning body portion 104 by applying a sufficient plug ejection pressure to the normally low-pressure side 116 to cause a breakaway force to break or separate the anchor element 164 from the plug 192. Disintegration of the destructible sealing disk 100 then occurs as described above.

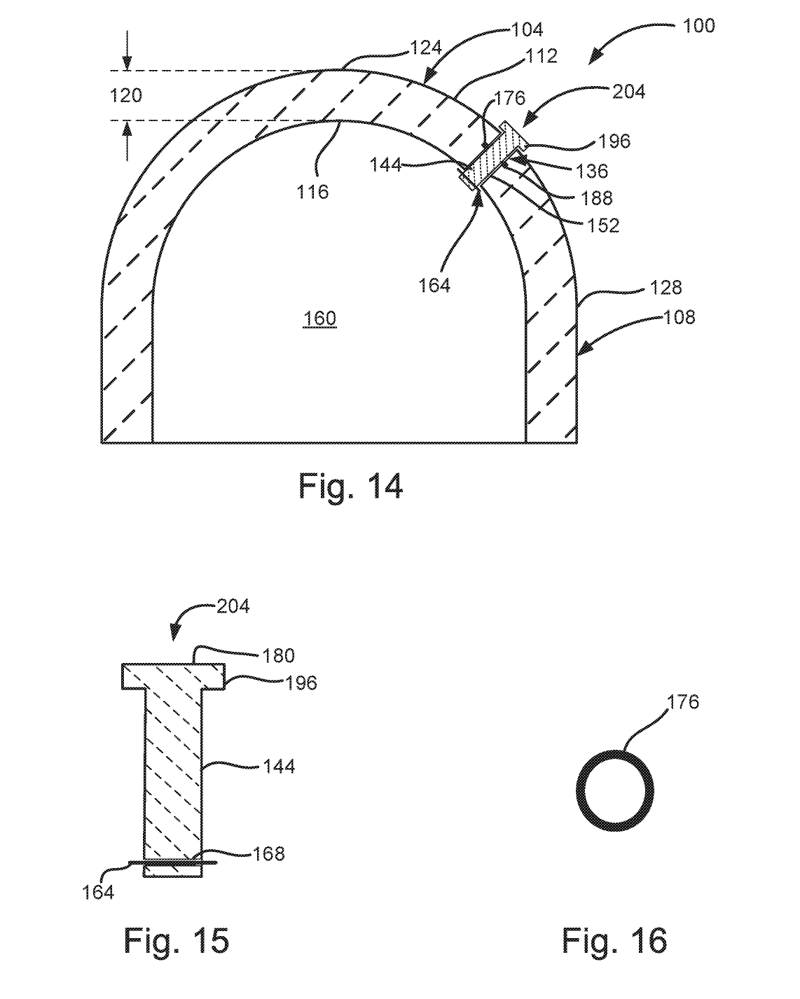

Referring now to FIGS. 14-16, a destructible sealing disk 100 is shown with still yet another embodiment of a plug. More particularly, plug 204 is similar to plug 192, however, plug 204 does not include a channel for an O-ring. As seen in FIG. 14, an O-ring channel 188 is set within the destructible sealing disk 100 at a location circumferentially outward of the plug shaft 144. When making the destructible sealing disk 100 of FIG. 14, the O-ring 176, as seen in FIG. 16, is fitted into the O-ring channel 188, and thereafter the plug 204 is positioned within the plug receptacle 136.

In use, the destructible sealing disk 100 with plug 204 functions similar to that described above for the destructible sealing disk 100 with plug 192. That is, normal operating pressure holds the plug 204 within the diameter-spanning body portion 104 because of the relatively high pressure on the plug distal surface 180. After normal operational use of the destructible sealing disk 100 with plug 204, the plug 204 can be ejected from the plug receptacle 136 of the diameter-spanning body portion 104 by applying a sufficient plug ejection pressure to the normally low-pressure side 116 to cause a breakaway force to break or separate the anchor element 164 from the plug 204. Disintegration of the destructible sealing disk 100 then occurs as described above.

As described above, the various plugs 132, 184, 192, 204 may comprise transverse cross-sections that are substantially circular, such that the plug receptacles are cylindrically shaped (although they may have different diameters along their longitudinal length) with gaskets shaped as O-rings. However, as those skilled in the art will appreciate, the plugs 132, 184, 192, 204 may also have different shapes in a transverse cross section, such as triangular, rectangular, pentagonal, hexagonal or otherwise polygon-shaped in transverse cross section, with gaskets, shaped to contact both the walls of the plug receptacle and the plug when the plug is fitted into the plug receptacle.

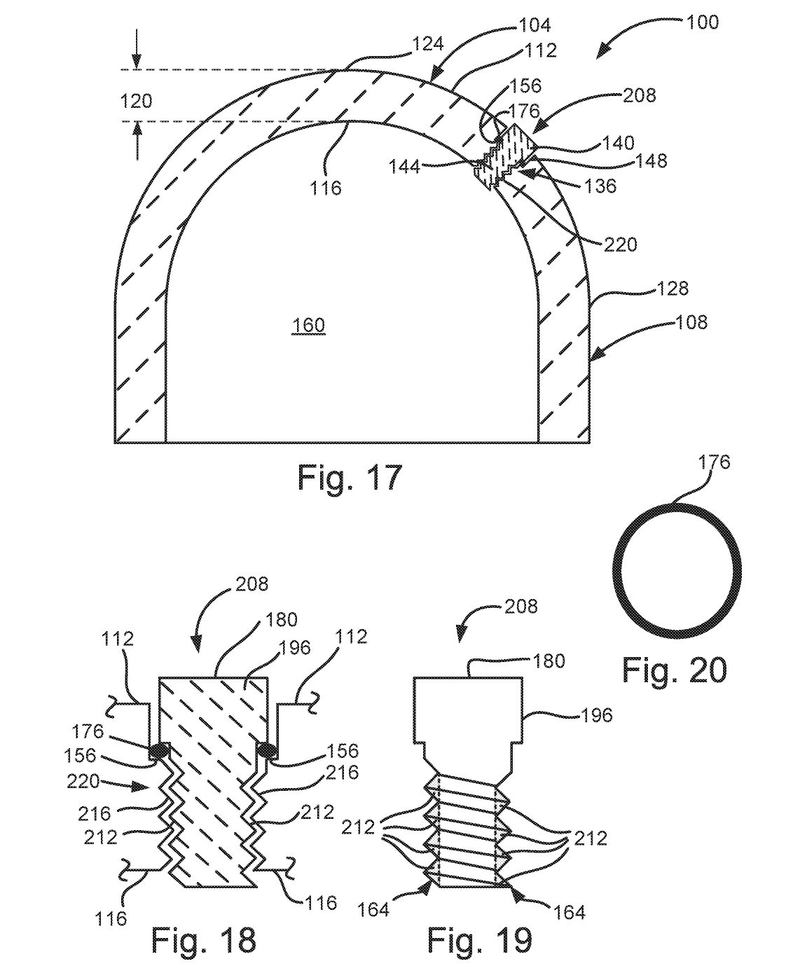

Referring now to FIGS. 17-20, a destructible sealing disk 100 is shown with still another embodiment of a plug. More particularly, plug 208 includes anchor element 164 comprising frangible threads 212 that threadably engage mating threads 216 located on a threaded receptacle portion 220 of the plug receptacle 136 within the diameter-spanning body portion 104. In the exemplary embodiment depicted in FIGS. 17-20, the plug receptacle 136 includes a distal receptacle portion 148 and the threaded receptacle portion 220. When assembling the destructible sealing disk 100 with plug 208, a gasket or an O-ring 176, is placed within the plug receptacle 136 to contact receptacle shoulder 156. Thereafter plug 208 is inserted into the plug receptacle 136 and rotated such that the frangible threads 212 of plug 208 threadably engage mating threads 216 of the threaded receptacle portion 220. The enlarged elevation view of FIG. 18 illustrates the location of the plug 208 relative to the threaded receptacle portion 220.

In use, normal operating pressure holds the plug 208 within the diameter-spanning body portion 104 because the relatively high pressure on the plug distal surface 180 maintains the plug within the diameter-spanning body portion 104. After normal operational use of the destructible sealing disk 100 with plug 208, the plug 208 can be ejected from the plug receptacle 136 of the diameter-spanning body portion 104 by applying a sufficient plug ejection pressure to the normally low-pressure side 116 to cause the frangible threads 212 to break, thereby forcing the plug 208 to be ejected from the plug receptacle 136. More particularly, as can be seen in FIG. 19, at least portions of the frangible threads 212 that serve as the anchor element 164 can be caused to break when a sufficient plug ejection pressure is applied to the normal low-pressure side 116 of the diameter-spanning body portion 104. Therefore, the frangible threads 212 of the plug 208 could be made of material suitable for being sheared under selective conditions. By way of non-limiting example, the threads may be made of aluminum or a copper alloy, such as brass or bronze material that is weaker in strength than the mating threads 216 of the threaded receptacle portion 220, which is preferably made of the corrodible material. A breakaway force for shearing the frangible threads 212 can be achieved after raising the pressure on the normally low-pressure side of the diameter-spanning body portion 104 above the pressure on the high-pressure side 112 of the diameter-spanning body portion 104, such as by raising the pressure on the low-pressure side 116 to between about 500 psi to 8,000 psi above the existing pressure on the high-pressure side 112 of the diameter-spanning body portion 104. After the plug 208 is ejected from the plug receptacle 136, disintegration of the destructible sealing disk 100 then occurs as described above.

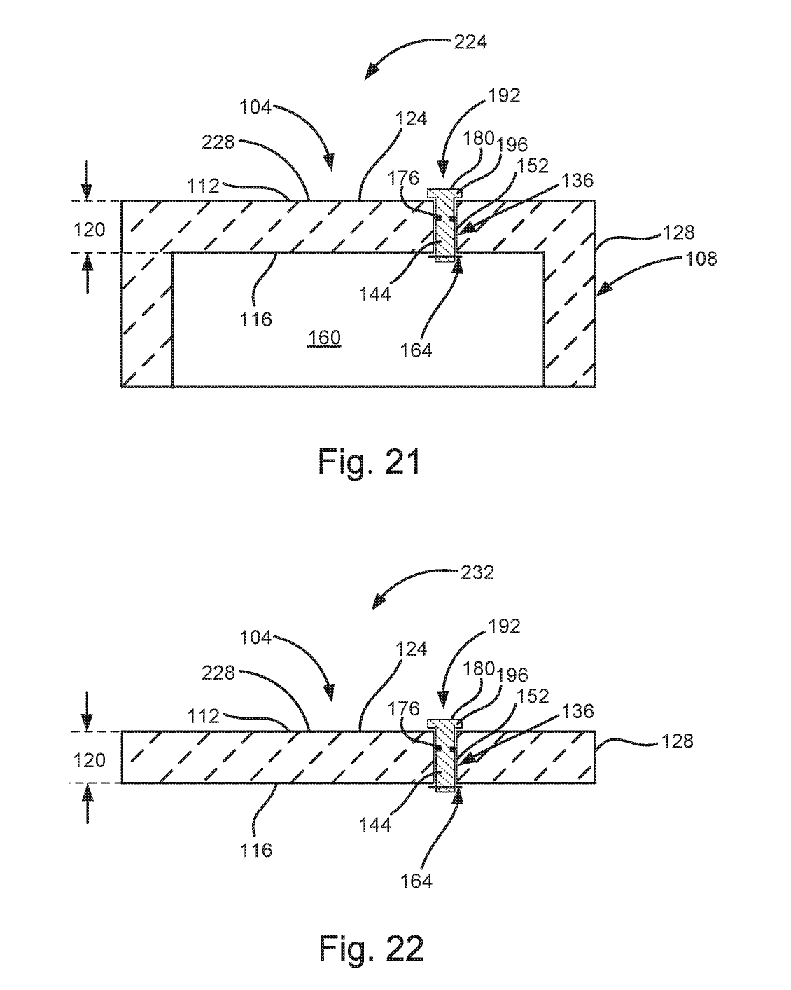

Referring now to FIG. 21, an alternative embodiment is illustrated, wherein the destructible sealing disk 224 includes a diameter-spanning portion 104 and the high-pressure side 112 of the diameter-spanning portion 104 is flat or substantially flat surface 224. More particularly, the high-pressure side 112 of the diameter-spanning portion 104 may be flat and does not possess a convex-shaped surface. In addition, the low-pressure side 116 of the diameter-spanning portion 104 may be flat and not possess a concave-shaped surface. For illustration purposes, the destructible sealing disk 224 shown in FIG. 21 is shown with plug 192. However, it is to be understood that other embodiments of plugs may be used with a diameter-spanning portion 104 that includes a flat or substantially flat high-pressure side 112 and/or flat or substantially flat low-pressure side 116.

Based on the illustrated figures of embodiments presented herein, the high-pressure side 112 of the diameter-spanning portion 104 may have a convex-shaped surface or the high-pressure side 112 of the diameter-spanning portion 104 may be flat or substantially flat. In addition, the low-pressure side 116 of the diameter-spanning portion 104 may have a concave-shaped surface or the low-pressure side 116 of the diameter-spanning portion 104 may be flat or substantially flat. In addition, the high-pressure side 112 of the diameter-spanning portion 104 may have a convex-shaped surface, while the low-pressure side 116 of the diameter-spanning portion 104 may be flat or substantially flat. In addition, the high-pressure side 112 of the diameter-spanning portion 104 may be flat, while the low-pressure side 116 of the diameter-spanning portion 104 may have a concave-shaped surface.

To maintain structural integrity for a given anticipated maximum operating pressure, for the destructible sealing disks 224 that include a flat or substantially flat high-pressure side 112, the thickness 120 of the diameter-spanning portion 104 may be thicker than the thickness 120 of the diameter-spanning portion 104 for a destructible seal disk 224 that possesses a concave-shaped high-pressure side 112. However, the destructible sealing disks 224 with a flat or substantially flat high-pressure side 112 offer the advantage of using less overall material. More particularly, while the thickness 120 of a flat or substantially flat destructible sealing disk 224 may be greater, less overall volume of material is used because an arcuate-shaped diameter-spanning portion 104 will require more overall material. In addition, a diameter-spanning portion 104 with a flat or substantially flat high-pressure side 112 may be easier to manufacture. Additionally or alternatively, a diameter-spanning portion 104 with flat or substantially flat high-pressure side and/or low-pressure side may more easily be fitted with a plug, such as one of the plugs 132, 184, 192, 204 described herein.

Referring now to FIG. 22, yet another embodiment of a destructible sealing disk 232 is shown. More particularly, the destructible sealing disk 232 of FIG. 22 is similar to the destructible sealing disk 224 shown in FIG. 21, however, the destructible sealing disk 232 of FIG. 22 does not include a circumferential rim portion 108. Accordingly, destructible sealing disk 232 of FIG. 22 is held in place by the delivery tool without the presence of the circumferential rim portion 108. Other aspects of the destructible sealing disk 232 of FIG. 22 are similar to those described above for the destructible sealing disk 224 of FIG. 21, including the diameter-spanning portion 104 being fitted with a plug, such as one of the plugs 132, 184, 192, 204 described herein.

In use, at least one of the destructible sealing disks 100, 224, or 232 are placed in a tool for use downhole. The tool with the destructible sealing disk 100, 224, or 232 is then inserted into a wellbore. The destructible sealing disk 100, 224, 232 prevents or limits fluids (gas and/or liquids) from migrating from the high-pressure side 112 of the diameter-spanning body portion 104 to the low-pressure side 116 of the diameter-spanning body portion 104. In contrast to sealing disks that require application of a tool or a material (e.g., acid) directed toward the sealing disks by using gravity to locate the tool or apply a material to cause the sealing disks to break apart, since the plug of the destructible sealing disk 100, 224, 232 can be ejected at any angle by the application of appropriate pressure to the low-pressure side 116 relative to the high-pressure side 112 of the diameter-spanning body portion 104, the destructible sealing disk 100, 224, 232 can therefore be oriented at any angle within the wellbore. Accordingly, the destructible sealing disk 100, 224, 232 has application to use in both vertical and horizontal wellbores, as well as portions of the wellbore transitioning between vertical and horizontal, or even at angles oriented upward.

By way of example, the destructible sealing disk 100, 224, 232 can be used to install piping in a horizontal section of a wellbore. In such use, the destructible sealing disk 100, 224, 232 can serve to seal the pipe being installed such that the portion of the pipe being installed contains air and tends to float within the well bore as the pipe is being installed. In another example, for production tubing being installed in a wellbore, the destructible sealing disk 100, 224, 232 can serve to prevent or limit wellbore fluids from entering the production tubing as it is being installed. For both of the foregoing examples, the destructible sealing disk 100, 224, 232 can be sufficiently corroded or dissolved with the application of appropriate pressure to the low-pressure side 116 relative to the high-pressure side 112 of the diameter-spanning body portion 104.

As noted above, it should be understood that the drawings are not necessarily to scale, including that the separation between the edges of the plugs and the plug receptacles are exaggerated for illustration purposes. Accordingly, the plugs may fit tighter within the plug receptacles than what may be inferred from the illustrations.

### REFERENCE NUMBER LIST

100 destructible sealing disk

104 diameter-spanning body portion

108 circumferential rim portion

112 high-pressure side

116 low-pressure side

120 thickness (of diameter-spanning body portion)

124 disk center

128 lateral edge (of the destructible sealing disk)

132 plug

136 plug receptacle

140 plug distal portion

144 plug shaft

148 distal receptacle portion

152 receptacle shaft portion

156 receptacle shoulder

160 interior space (of destructible sealing disk)

164 anchor element

168 anchor port

172 channel (for gasket or O-ring)

176 O-ring (or gasket)

180 plug distal surface

184 plug

188 O-ring channel

192 plug

196 plug cap

200 channel (for gasket or O-ring)

204 plug

208 plug

212 frangible threads (on plug)

216 mating threads (on plug receptacle)

220 threaded receptacle portion (of plug receptacle)

224 destructible sealing disk

228 flat surface (on high-pressure side of diameter-spanning body portion)

232 destructible sealing disk

A1 high-pressure arrows

A2 low-pressure arrows

A3 breakaway-pressure arrows

Various embodiments have been described, which are intended in all respects to be illustrative rather than restrictive. Alternative embodiments will become apparent to those of ordinary skill in the art to which the present invention pertains without departing from its scope. It will be understood that certain features and subcombinations are of utility and may be employed without reference to other features and subcombinations.

What is claimed is:

1. A drill piping or tubing pressure seal, comprising:
a diameter-spanning body portion connected to a circumferential rim portion, the diameter-spanning body portion including a high-pressure side, a low-pressure side and a plug receptacle passing through the diameter-spanning body portion from the high-pressure side to the low-pressure side, wherein the high-pressure side and the low-pressure side of the diameter-spanning body portion include a protective coating, and wherein an interior surface of the plug receptacle located between the high-pressure side and the low-pressure side does not include the protective coating;
a plug configured to be located within the plug receptacle, the plug configured to be retained within the plug receptacle by an anchor element to maintain the plug within the plug receptacle until a breakaway force of the anchor element is exceeded; and
a gasket located between a portion of the plug and the plug receptacle.

2. The drill piping or tubing pressure seal according to claim 1, wherein the diameter-spanning body portion and the circumferential rim portion are a single monolithic piece.

3. The drill piping or tubing pressure seal according to claim 1, wherein the diameter-spanning body portion and the circumferential rim portion are integrally formed.

4. The drill piping or tubing pressure seal according to claim 1, wherein the diameter-spanning body portion and the circumferential rim portion are made of a corrodible material configured to structurally degrade when the plug receptacle is exposed to oil and gas well fluids and/or an acid.

5. The drill piping or tubing pressure seal according to claim 1, wherein the protective coating comprises phenolic epoxy.

6. The drill piping or tubing pressure seal according to claim 1, wherein the anchor element includes frangible threads on the plug configured for threadably mating with mating threads on the plug receptacle.

7. The drill piping or tubing pressure seal according to claim 1, wherein the anchor element includes a frangible pin configured to contact a portion of the plug.

8. The drill piping or tubing pressure seal according to claim 7, wherein the frangible pin is configured to extend through an anchor port of the plug.

9. The drill piping or tubing pressure seal according to claim 8, wherein the frangible pin is configured to contact the low-pressure side of the diameter-spanning body portion when the breakaway force is applied to the anchor element.

10. The drill piping or tubing pressure seal according to claim 1, wherein the diameter-spanning body portion is domed-shaped, and wherein the high-pressure side is a convex surface and the low-pressure side is a concave surface.

11. The drill piping or tubing pressure seal according to claim 1, wherein the diameter-spanning body portion is not dome-shaped.

12. The drill piping or tubing pressure seal according to claim 1, wherein the high-pressure side of the diameter-spanning portion is flat or substantially flat.

13. The drill piping or tubing pressure seal according to claim 1, wherein the low-pressure side of the diameter-spanning portion is flat or substantially flat.

14. The drill piping or tubing pressure seal according to claim 1, wherein the gasket comprises an elastomeric material.

15. The drill piping or tubing pressure seal according to claim 1, wherein the gasket comprises an adhesive.

16. The drill piping or tubing pressure seal according to claim 1, wherein the gasket comprises an O-ring.

17. The drill piping or tubing pressure seal according to claim 1, wherein at least a portion of the plug receptacle comprises a transversely oriented circular-shaped cross section.

18. The drill piping or tubing pressure seal according to claim 1, wherein at least a portion of the plug receptacle comprises a transversely oriented polygon-shaped cross section.

19. A drill piping or tubing pressure seal, comprising:
a diameter-spanning body portion including a high-pressure side, a low-pressure side and a plug receptacle passing through the diameter-spanning body portion from the high-pressure side to the low-pressure side, wherein the high-pressure side and the low-pressure side of the diameter-spanning body portion include a protective coating, and wherein an interior surface of the plug receptacle located between the high-pressure side and the low-pressure side does not include the protective coating;
a plug configured to be located within the plug receptacle, the plug configured to be retained within the plug receptacle by an anchor element to maintain the plug within the plug receptacle until a breakaway force of the anchor element is exceeded; and
a gasket located between a portion of the plug and the plug receptacle.

20. The drill piping or tubing pressure seal according to claim 19, wherein the high-pressure side of the diameter-spanning portion is flat or substantially flat.

21. The drill piping or tubing pressure seal according to claim 19, wherein the low-pressure side of the diameter-spanning portion is flat or substantially flat.

22. The drill piping or tubing pressure seal according to claim 19, wherein the gasket comprises an elastomeric material.
